(19) United States
(12) Patent Application Publication
(10) Pub. No.: US 2007/0236559 A1
(43) Pub. Date: Oct. 11, 2007

(54) Video Phone Terminal Apparatus and Address Display Method

(75) Inventor: Ryunosuke KAWASHIMA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Sony Corporation

(21) Appl. No.: 11/733,002

(22) Filed: Apr. 9, 2007

(30) Foreign Application Priority Data
Apr. 10, 2006 (JP) P2006-108092

(51) Int. Cl. H04N 7/14

(52) U.S. Cl. 348/14.02

(57) ABSTRACT

A video phone terminal apparatus that communicates with another video phone terminal apparatus over a private network and a global network includes a unique address defining section defining a unique address of a terminal of the apparatus, an address-upon-connection obtaining section obtaining an address upon connection of the terminal to the private network, and an address display section displaying an address unique to the terminal, which is defined by the unique address defining section, and the address upon connection of the terminal, which is obtained by the address-upon-connection obtaining section.

### CROSS REFERENCES TO RELATED APPLICATIONS

The present invention contains subject matter related to Japanese Patent Application JP 2006-108092 filed in the Japanese Patent Office on Apr. 10, 2006, the entire contents of which being incorporated herein by reference.

### BACKGROUND OF THE INVENTION

1. Field of the Invention

The present invention relates to a video phone terminal apparatus that communicates with another video phone terminal apparatus over a network, for example, and an address display method.

2. Description of the Related Art

A general videoconference system, for example, has been disclosed in the past which includes one or more terminal apparatus provided at difference positions and an information processing apparatus connecting to the terminal apparatus over a predetermined network, wherein data is transmitted to the terminal apparatus over the network (refer to JP-A-2005-328484 (Patent Document 1)).

The videoconference system creates a synthesized picture resulting from the synthesis of a picture of a user, which is transmitted from the terminal apparatus over the network, and an image of a necessary document, scales up or down the image of the document and/or the corresponding user's picture in the synthesized picture based on the presence of a user's comment, which is detected based on a document operation and/or voice data, and transmits synthesized picture data of the created synthesized picture.

In order to connect to the other terminal over an ISDN (Integrated Services Digital Network), which is a high speed communication line, in the videoconference system in the past, an ISDN number of the other terminal is dialed.

Alternatively, in order to connect to the other terminal over a private IP (internet Protocol) network in the videoconference system in the past, a private IP address of the other terminal is dialed.

### SUMMARY OF THE INVENTION

The connection to the other terminal over an ISON in the past disadvantageously has a low communication speed and charges on as-used basis though the connection to the other terminal can be securely performed. Though the connection to the other terminal over a private IP network in the past has a high communication speed, the IP address may often be obtained by DHCP (Dynamic Host Configuration Protocol), which is widely spread in general and may take time for the network construction and increase the costs. Furthermore, the private IP network address may vary disadvantageously for each connection to the network.

The DHCP refers to a protocol by which necessary information such as an IP address is automatically assigned to a computer that temporarily connects to the Internet, and a DHCP server has settings of ranges of an IP address or IP addresses of a gateway server and/or DNS server, a subnet mask and an IP address, which may be assigned to a client, and provides the information to a computer that accesses thereto by dial-up connection, for example. When a client exits communication, the address is automatically collected and is assigned to another computer. The use of DHCP allows a user who is not familiar with network settings to connect to the Internet easily and allows a network manager to centrally manage many clients easily.

Furthermore, in order to connect the other terminal from a private IP network through a global IP network, which is the public Internet, as described above, the global IP network address of the other terminal may be dialed, which may reduce the cost for network construction and increase the communication speed.

However, since the private IP address is rewritten by NAT (Network Address Translation), which is widely spread in general, it takes time to obtain the global IP network address of the other terminal.

Here, NAT refers to a technology for efficiently using a limited IP address resource by converting an IP address and/or establishing a firewall in a network such as the Internet based on TCP/IP (Transmission Control Protocol/Internet Protocol) and may often be implemented in a router (such as a broadband router) for connecting to the Internet.

In order to use the Internet, a global IP address, which is officially assigned to be unique in the world, may be required to give to a node that connects to the Internet. However, because of the rapid spread of the Internet, the global IP addresses may be depleted in the near future. Therefore, a private IP address may be broadly used in an organization, and a global IP address may be assigned only to a node, which is actually necessary to connect to the Internet, for each connection. This technology allows a company connecting to the Internet, for example, to save global addresses, which may be often insufficient, and to hide internal private IP addresses from the Internet, which is effective in security. For these reasons, the technology has been widely spread.

Therefore, calling to the other party by a video phone may require obtaining, in some way, an IP address on a WAN (Wide Area Network), which is a global IP network of a router provided between a private IP network and the global IP network.

In this case, the global IP network address of the router is not displayed on the GUI (Graphical User Interface) of the terminal, but the private IP address of the terminal is only displayed thereon. Therefore, the global IP network address of the router may not be notified to the other party through a telephone line, for example, which is inconvenient.

Accordingly, it is desirable to propose a video phone terminal apparatus and address display method that allow address display, which is convenient for the connection to the other terminal over a private IP network and a global IP network.

According to an embodiment of the present invention, there is provided a video phone terminal apparatus that communicates with another video phone terminal apparatus over a private network and a global network, the apparatus including a unique address defining section defining a unique address of a terminal of the apparatus, an address-upon-connection obtaining section obtaining an address upon connection of the terminal to the private network, and an address display section displaying an address unique to the terminal, which is defined by the unique address defining section, and the address upon connection of the terminal, which is obtained by the address-upon-connection obtaining section.

According to another embodiment of the invention, there is provided an address display method in a video phone terminal apparatus that communicates with another video phone terminal apparatus over a private network and a global network, the method including the steps of defining a unique address of a terminal of the apparatus, obtaining an address upon connection of the terminal to the private network, and displaying an address unique to the terminal, which is defined by the step of defining a unique address, and the address upon connection of the terminal, which is obtained by the step of obtaining the address upon connection.

Thus, the unique address defining section defines a unique address of the terminal, and the address-upon-connection obtaining section obtains the address upon connection of the terminal to a private network. The address display section displays the unique address of the terminal, which is defined by the unique address defining section, and the address upon connection of the terminal, which is obtained by the address-upon-connection obtaining section.

According to the embodiments of the invention, address information in accordance with a wide variety of communication infrastructures and system configurations can be provided though the GUI on the screen of a videoconference system in the past which generally displays one piece of address information. In particular, both of a unique address and an address upon connection can be displayed by a simple operation on a screen as the terminal address information, which is necessary for connection. Therefore, the usability is increased, which may improve the operability.

### BRIEF DESCRIPTION OF THE DRAWINGS

FIG. 1 is a block diagram showing a construction of a video phone terminal apparatus;

FIG. 2 is a flowchart showing an operation of defining a unique address;

FIG. 3 is a flowchart showing an operation of obtaining an address upon connection;

FIG. 4 is a flowchart showing an operation of displaying a unique address;

FIG. 5 is a flowchart showing an operation of displaying an address upon connection;

FIG. 6 is a flowchart showing an operation of obtaining a global router IP address upon startup;

FIG. 7 is a diagram showing a usage of a video phone system;

FIG. 8 is a diagram showing a usage of another video phone system;

FIG. 9 is a diagram showing a usage of another video phone system;

FIG. 10 is a diagram showing a usage of another video phone system; and

FIG. 11 is a diagram showing a usage of another video phone system.

### DESCRIPTION OF THE PREFERRED EMBODIMENTS

With reference to drawings properly, embodiments of the invention will be described in detail below.

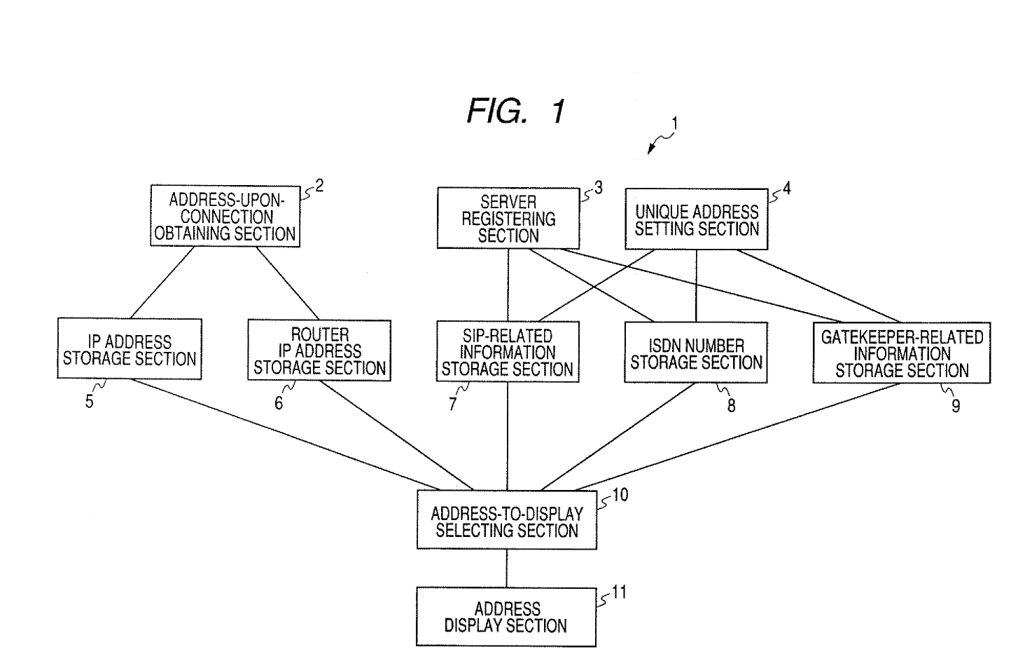

FIG. 1 is a block diagram showing a construction of a video phone terminal apparatus.

In FIG. 1, a video phone terminal apparatus 1 is capable of communicating with another video phone terminal apparatus over a private network and a global network.

The video phone terminal apparatus 1 includes a unique address defining section 4 defining a unique address of the terminal and an address-upon-connection obtaining section 2 obtaining an address upon connection of the terminal to a private network.

The video phone terminal apparatus 1 further includes a display address selecting section 10 and an address display section 11. The display address selecting section 10 selects a unique address of the terminal, which is defined by the unique address defining section 4, and an address upon connection of the terminal, which is obtained by the address-upon-connection obtaining section 2, for display. The address display section 11 displays the unique address of the terminal, which is defined by the unique address defining section 4, and the address upon connection of the terminal, which is obtained by the address-upon-connection obtaining section 2.

Here, the unique address of the terminal, which Is defined by the unique address defining section 4, includes an ISDN number, which is an ISDN line number of the terminal, a user name and user number registered with a gatekeeper, a user name registered with an SIP (Session Initiation Protocol) server and an SIP_URI (Uniform Resource Identifier).

The video phone terminal apparatus 1 further includes an ISDN number storage section 8, a server-related information storage section 7 and a gatekeeper-related information storage section 9. The ISDN number storage section 8 stores an ISDN number, which is an ISDN line number, of the terminal. The server-related information storage section 7 stores information related to a server including an address thereof. The gatekeeper-related information storage section 9 stores information related to a gatekeeper including an address thereof.

The video phone terminal apparatus 1 further includes a server registering section 3 registering the ISDN number, which is a telephone line number, stored in the ISDN number storage section 8, a server address stored in the server-related information storage section 7, and a gatekeeper address stored in the gatekeeper-related information storage section 9 with the storage section in the server or gatekeeper.

The address upon connection of the terminal, which is obtained by the address-upon-connection obtaining section 2, includes an IP address on a private network of the terminal and an IF address on a global network of a router provided between a global network and the terminal.

Here, the video phone terminal apparatus 1 further includes a private network terminal IF address storage section 5 and a global network router IF address storage section 6. The IF address storage section 5 stores the address of the terminal on a private network. The router IF address storage section 6 stores the IP address of the router on a global network.

Upon startup of the terminal, the address-upon-connection obtaining section 2 is capable of obtaining the IF address of the terminal on a private network from a DHCP server on the private network and obtaining a WAN side IF address of the router from the router on a global network.

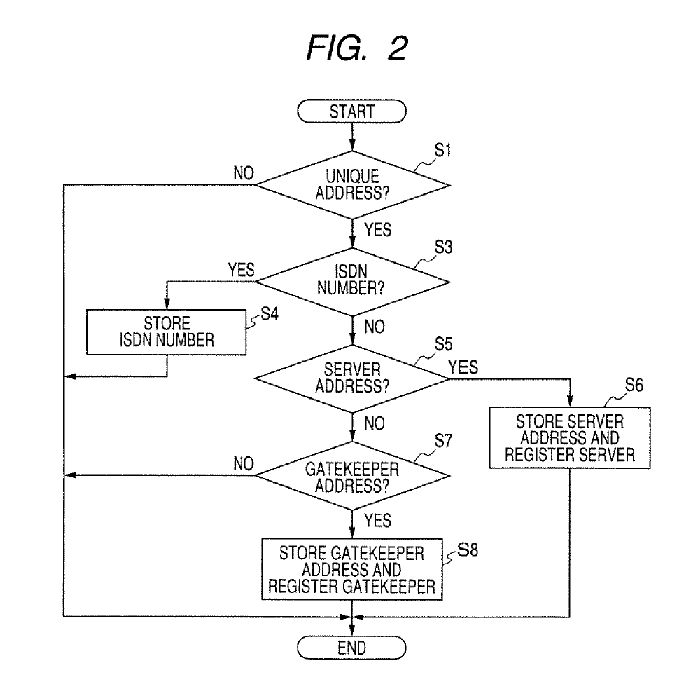

FIG. 2 is a flowchart showing an operation of defining a unique address. FIG. 2 shows an operation by the unique address defining section 4.

In FIG. 2, the unique address defining section 4 determines whether a unique address is to be defined or not (step S1). The unique defining section 4 determines whether the unique address to be defined is an ISDN number or not (step S3).

If it is determined in step S3 that the unique address to be defined is an ISDN number, the unique address defining section 4 stores an ISDN number in the ISDN number storage section 8 (step S4).

If it is determined in step S3 that the unique address to be defined is not an ISDN number, the unique address defining section 4 determines whether the unique address to be defined is a server address or not (step S5).

If it is determined in step S5 that the unique address to be defined is an SIP server address, the unique address defining section 4 stores an SIP server address and a user name and SIP_URI in the SIP-related information storage section 7 and registers them with the storage section of the SIP server on the global network or the private network (step S6).

Since it is determined in step S5 that the unique address to be defined is not a server address after the storage and registration of the server address with the server in step S6, the unique address defining section 4 determines whether the unique address to be defined is a gatekeeper address or not (step S7).

If it is determined in step S7 that the unique address to be defined is a gatekeeper address, the unique address defining section 4 stores a gatekeeper address, a user name and a user number in the gatekeeper-related information storage section 9 and registers them with the storage section of the gatekeeper on the global network or private network (step S8).

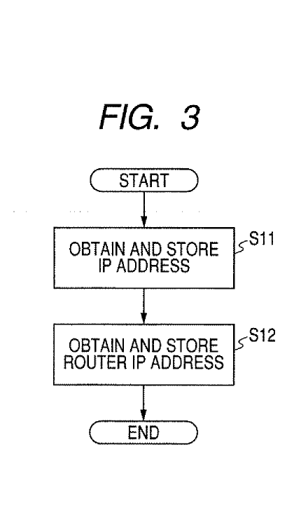

FIG. 3 is a flowchart showing an operation of obtaining an address upon connection. FIG. 3 shows an operation by the address-upon-connection obtaining section 2.

In FIG. 3, the address-upon-connection obtaining section 2 obtains the IP address on a private network of the terminal from the DHCP server on the private network and stores the obtained IP address of the terminal in the IP address storage section 5 (step S11).

Next, the address-upon-connection obtaining section 2 obtains the IP address on a global network of the router from the router on the global network and stores the obtained IP address on the global network of the router in the router IP address storage section 6 (step S12).

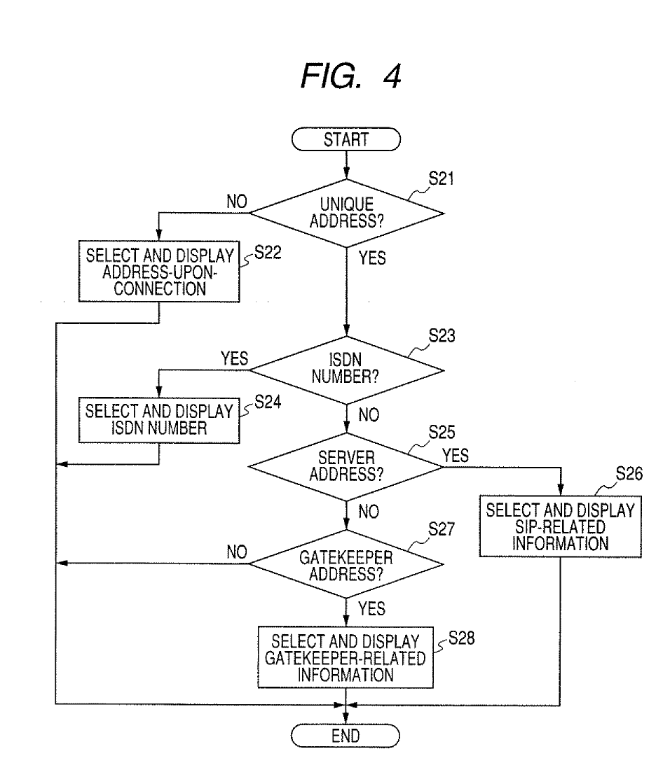

FIG. 4 is a flowchart showing an operation of displaying a unique address. FIG. 4 shows operations by the display address selecting section 10 and address display section 11.

In FIG. 4, the display address selecting section 10 determines whether the address to be displayed by the address display section 11 is a unique address or not (step S21).

If it is determined in step S21 that a unique address is not to be displayed, the processing moves to the processing of selecting and displaying an address upon connection, which will be described later (step S22), if it is determined in step S21 that a unique address is to be displayed, the display address selecting section 10 determines whether the unique address to be displayed is an ISDN number or not (step S23).

If it is determined in step S23 that the unique address to be displayed is an ISDN number, the address display section 11 loads an ISDN number from the ISDN number storage section 8 and displays it on the display section (step S24).

Since it is determined in step S23 that the unique address to be displayed is not an ISDN number after the ISDN number is displayed in step S24, the display address selecting section 10 determines whether the unique address to be displayed is an SIP server address or not (step S25).

If it is determined in step S25 that the unique address to be displayed is an SIP (Session Initiation Protocol) server address, the address display section 11 loads the user name and SIP_URI, which are registered with the SIP-related information storage section 7 and displays them on the display section (step S26).

Since it is determined in the next step S25 that the unique address to be displayed is not an SIP server address after the user name and SIP_URI, which are registered with the SIP-related information storage section 7, are displayed in step S26, the display address selecting section 10 determines whether the unique address to be displayed is a gatekeeper address or not (step S27).

If it is determined in step S27 that the unique address to be displayed is a gatekeeper address, the address display section 11 loads the user name and user number, which are registered with the gatekeeper, from the gatekeeper-related information storage section 9 and displays them on the display section (step S28).

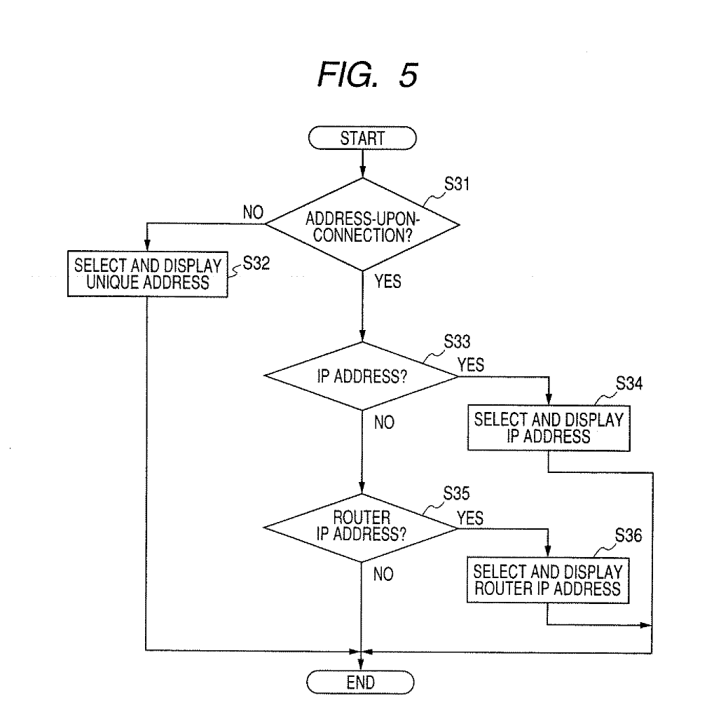

FIG. 5 is a flowchart showing an operation of displaying an address upon connection. FIG. 5 shows operations by the display address selecting section. 10 and address display section 11.

In FIG. 5, the display address selecting section 10 determines whether an address upon connection is to be displayed or not (step S31). If it is determined in step S31 that an address upon connection is not to be displayed, the processing moves to the processing of displaying the unique address (step S32), as described above.

If it is determined in step S31 that an address upon connection is to be displayed, the display address selecting section 10 determines whether an address upon connection to be displayed is an IP address on a private network of the terminal or not (step S33).

If it is determined in step S33 that the address upon connection to be displayed is an IP address on a private network of the terminal, the address display section 11 displays the IP address on the private network of the terminal, which has been loaded from the IP address storage section 5, on the display section (step S34).

Since it is determined in the next step S33 that the address upon connection to be displayed is not an IP address on a private network of the terminal after the IP address of the terminal is displayed in step S34, the display address selecting section 10 determines whether the address upon connection to be displayed is an IP address on a global network of the router or not (step S35)

If it is determined in step S35 that an address upon connection to be displayed is an IP address on a global network of the router, the address display section 11 displays the IP address on the global network of the router, which has been loaded from the router IP address storage section 6, on the display section (step S36).

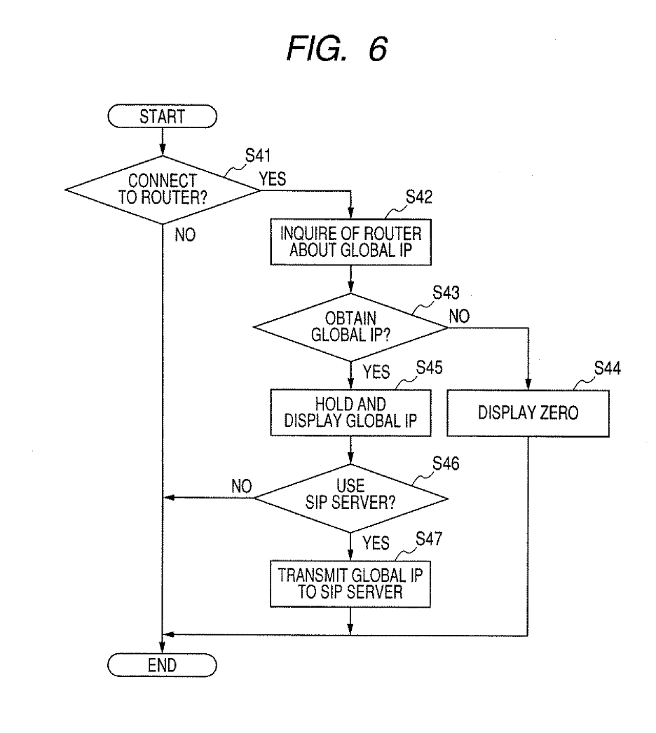

FIG. 6 is a flowchart showing an operation of obtaining a global router IP address upon startup. FIG. 6 shows operations by the address-upon-connection obtaining section 2, display address selecting section 10 and address display section 11.

In FIG. 6, the address-upon-connection obtaining section 2 upon startup determines whether the global IP address assigned to the router is to be obtained or not (step 541).

If it is determined in step S41 that the global IP address assigned to the router is to be obtained, the address-upon-connection obtaining section 2 inquires of the router the global router I address on the global network (step S42).

The address-upon-connection obtaining section 2 determines whether the global IP address has been obtained successfully or not (step S43).

If it is determined in step S43 that the global IP address has been obtained successfully, the address-upon-connection obtaining section 2 stores the obtained global IP address in the router IP address storage section 6.

Then, the display address selecting section 10 determines whether the address to be displayed upon connection is the global IP address or not. The address display section 11 loads the global IP address from the router IP address storage section 6 and displays it on the display section (step S45)

In this case, if it is determined in step S43 that the global IP address has not been obtained, the address-upon-connection obtaining section 2 stores a specific value such as “zero (0)” in the router IP address storage section 6 as the global IP address.

Then, if the display address selecting section 10 determines that the address to be displayed upon connection is the global IP address, the address display section 11 loads a specific value such as “zero (0)” from the router IP address storage section 6 as the global IP address and displays it on the display section (step S44).

After the global IP address obtained in step S45 is displayed on the display section, the address-upon-connection obtaining section 2 determines whether a server (such as an SIP server) on the global network is to be used or not (step S46).

If it is determined in step S46 that the SIP server on the global network is to be used, the address-upon-connection obtaining section 2 transmits the global IP address obtained in step S45 to the SIP server on the global network (step S47). Thus, by accessing the global IP address through the SIP server, the terminal can communicate with the terminal of the other communication party.

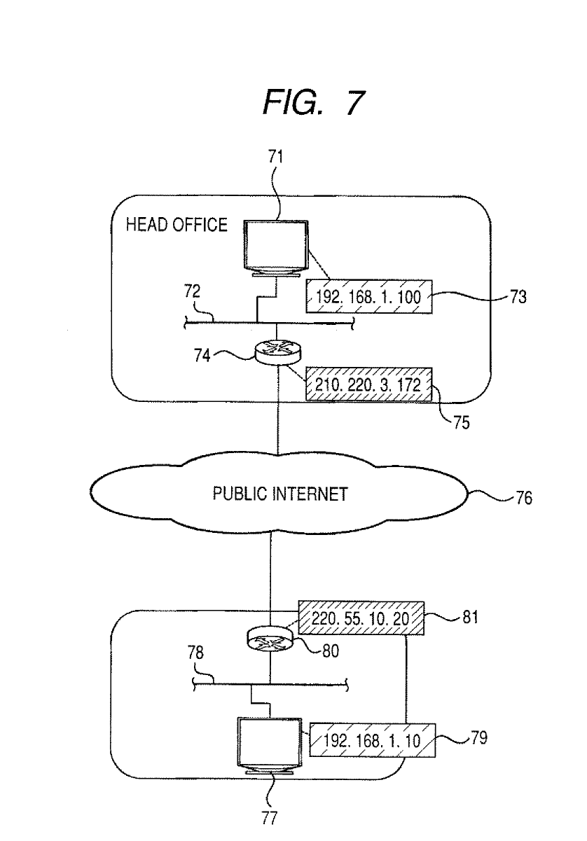

FIG. 7 is a diagram showing a usage of a video phone system.

FIG. 7 shows an example in which a video phone terminal apparatus 71 on one private network 72 communicates with a video phone terminal apparatus 77 on the other private network 78 over the public Internet 76, which is a global network.

One router 74 is provided between the one private network 72 and the public Internet 76, and the other router 80 is provided between the other private network 78 and the public Internet 76.

In this case, if the processing of obtaining an address upon connection is for an IP address on the private network of the terminal, the one address-upon-connection obtaining section 2 obtains an IP address 73 of the terminal on the one private network 72 from a DHCP server on the private network 72 and stores the obtained IP address 73 of the terminal in the one IP address storage section 5.

If the processing of obtaining an address upon connection is for a global IP address 75 on the public Internet 76, which is a global network, of the one router 74, the one address-upon-connection obtaining section 2 obtains the global IP address 75 on the public Internet 76, which is a global network, of the one router 74 from the one router 74 on the public Internet 76, which is a global network.

Then, the one address-upon-connection obtaining section 2 stores the obtained global IP address 75 on the public Internet 76, which is a global network, of the one router 74 In the one router IP address storage section 6.

In the same manner, if the processing of obtaining an address upon connection is for an IP address on the private network of the terminal, the other address-upon-connection obtaining section 2 obtains an IP address 79 on the other private network 78 of the terminal from a DHCP server on the other private network 78 and stores the obtained IP address 79 of the terminal in the other IP address storage section 5.

If the processing of obtaining an address upon connection is for a global IP address 81 on the public Internet 76, which is a global network, of the other router 80, the other address-upon-connection obtaining section 2 obtains the global IP address 81 on the public Internet 76, which is a global network, of the other router 80 from the other router 80 on the public Internet 76, which is a global network.

Then, the other address-upon-connection obtaining section 2 stores the obtained global IP address 81 on the public Internet 76, which is a global network, of the other router 80 in the other router IF address storage section 6.

Thus, the one or other address-upon-connection obtaining section 2 can obtain the global IF address 75 or 81 automatically without particularly searching it and therefore can store the global IF address 75 or 81, which is differently assigned every connection, in the terminal so as to display it by default.

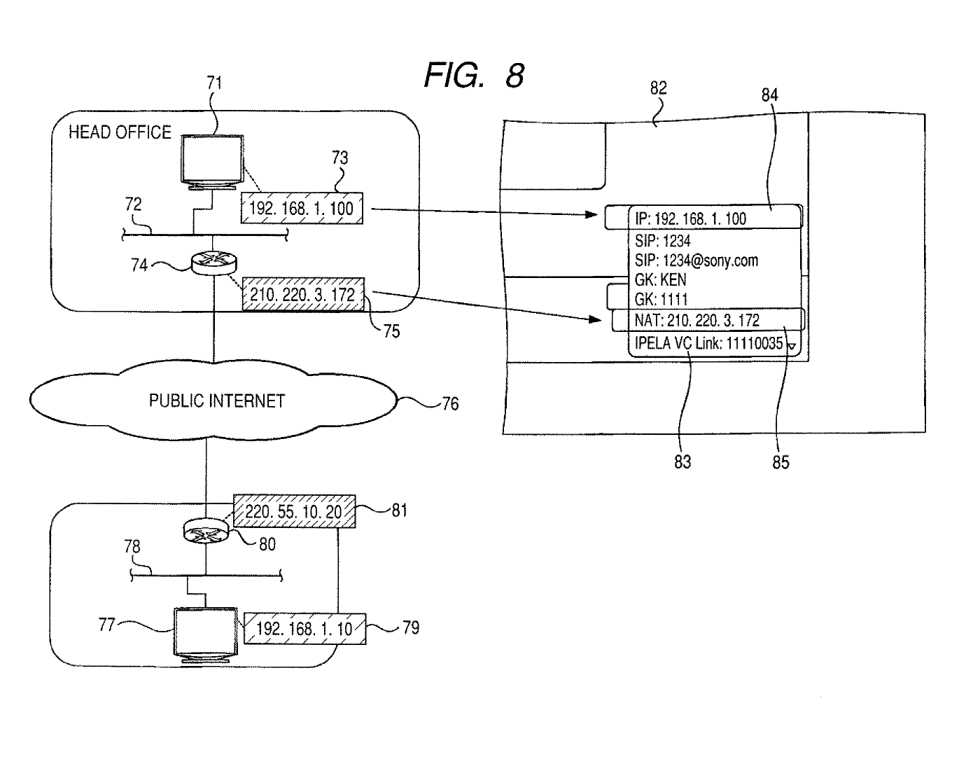

FIG. 8 is a diagram showing a usage of another video phone system. FIG. 8 shows an example in which the IF address 73 and global IP address 75 of the terminal, which are obtained by the one address-upon-connection obtaining section 2 and stored in the terminal as in FIG. 7, are displayed.

In FIG. 8, an address display section 83 is displayed on a display screen 82 on the video phone terminal apparatus 71 on the one private network 72. The address display section 83 displays items “IP” and “NAT (Network Address Translation”. Under “IP”, an IF address 84 is displayed which corresponds to the IF address 73 of the terminal shown in FIG. 7. Under “NAT”, a global router IP address 85 is displayed which corresponds to the global IP address 75 shown in FIG. 7.

In this case, the address display section 83 displays a user name registered with an SIP server under “SIP” above and displays SIP_URI registered with the SIP server under the “SIP” below.

The address display section 83 displays other items “GK (GateKeeper)” and “IPELA VC link”. The address display section 83 displays a user name registered with a gatekeeper as a name under “GK (Gatekeeper)” above, a user number registered with the gatekeeper as a unique number under “GK” below and displays the address of the terminal as a unique number registered with the SIP server on the public Internet under “IPELA VC link”.

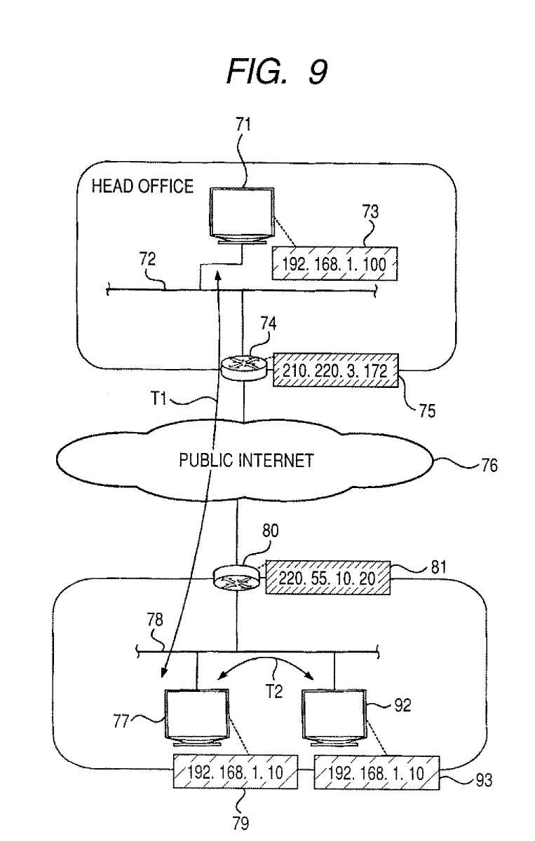

FIG. 9 is a diagram showing a usage of another video phone system. FIG. 9 shows examples of the communication with the other terminal over the public Internet 76, which is a global network, shown in FIG. 7 and the communication with the other party within the same private network 78.

In FIG. 9, the address display section 83 on the video phone terminal apparatus 71 on the one private network 72 displays the private IP address 73 of the terminal and the Internet side global IP address 75 of the router.

The address display section 83 on the video phone terminal apparatus 77 on the other private network 78 displays the private IP address 79 and global IP address 81 of the terminal. In this case, the address display section 83 of a video phone terminal apparatus 92 on the same private network 78 also displays the private IP address 93 and global IP address 81 of the terminal.

In this case, in order to communicate with the other terminal over the public Internet 76, which is a global network, as indicated by the point in time T1, the global router IP address 75 displayed on the address display section 83 on the video phone terminal apparatus 71 on the one private network 72 is notified to the other communication party through a telephone line, for example.

The global IP address 81 displayed on the address display section 83 on the video phone terminal apparatus 77 on the other private network 78 is notified to the other communication party through a telephone line, for example.

Thus, by selecting and notifying the global ID addresses 75 and 81, which are differently assigned every connection to the public Internet 76 that is a global network, to the other communication party in accordance with the network that the other terminal to communicate belongs to, the global IP addresses 75 and 81 of the terminals can be notified to each other. Therefore, the communication with each other can be implemented by dialing the global IP address 75 or 81 of the other terminal.

In order to communicate with the other terminal within the same private network 78 as indicated by the point in time T2, the IP address 79 of the terminal, which is displayed on the address display section 83 on the video phone terminal apparatus 77 on the same private network 78, is notified to the other communication party through a telephone line, for example. The IP address 93 of the terminal, which is displayed on the address display section 83 on the video phone terminal apparatus 92 on the same private network 78, is notified to the other communication party through a telephone line, for example.

Thus, by selecting and notifying the IP addresses 79 and 93 of the terminal, which are differently assigned every connection to the other private network 78, to the other communication party in accordance with the network that the other terminal to communicate belongs to, the IP addresses 79 and 93 of the other terminals can be notified to each other. Therefore, the communication with each other can be implemented by dialing the IP address 79 or 93 of the other terminal.

In this way, good communication with the other communication terminal over the public Internet or within a same private network can be achieved at the point in time T1 and the subsequent point in time T2 by selecting an address displayed in accordance with the network that the other communication terminal belongs to and notifying it to the other communication party.

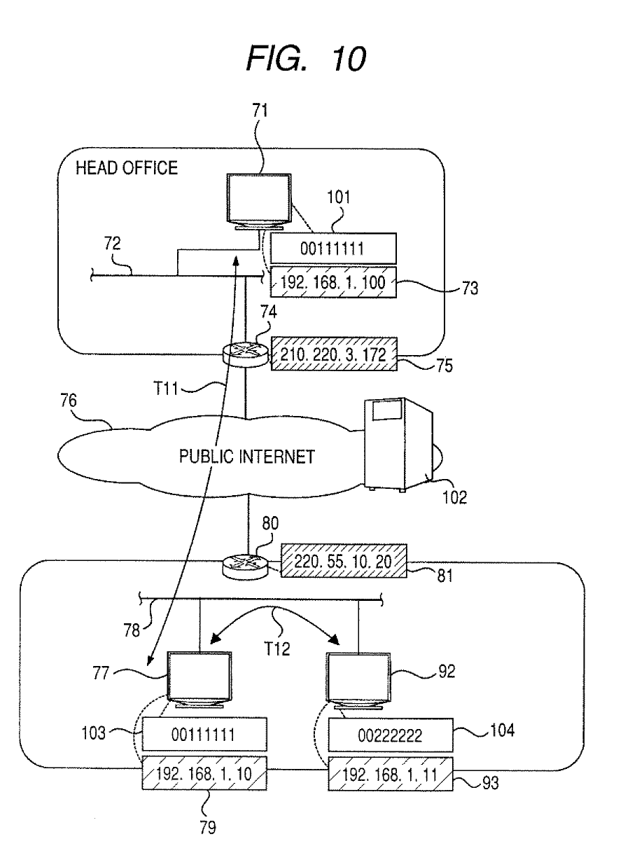

FIG. 10 is a diagram showing a usage of another video phone system. FIG. 10 shows an example in which an SIP server or gatekeeper indicated by the reference numeral 102 is employed in the case shown in FIG. 9.

In FIG. 10, an IP address 73 and global IP address 75 of the terminal are displayed on the address display section 83 on the video phone terminal apparatus 71 on the one private network 72. The address display section 83 further displays a unique number 101 indicating the address of the terminal, which is registered with an SIP server or gatekeeper indicated by the reference numeral 102, on the public Internet 76, which is a global network.

An IP address 79 and global IP address 81 of the terminal are displayed on the address display section 83 on the video phone terminal apparatus 77 on the other private network 78. The address display section 83 further displays a unique number 103 indicating the address of the terminal, which is registered with the SIP server or gatekeeper indicated by the reference numeral 102, on the public Internet 76, which is a global network.

An IP address 93 and global IP address 81 of the terminal are displayed on the address display section 83 on the video phone terminal apparatus 92 on the other private network 78. The address display section 83 further displays a unique number 104 indicating the address of the terminal, which is registered with the SIP server or gatekeeper indicated by the reference numeral 102, on the public Internet 76, which is a global network.

In this case, in order to communicate with the other terminal over the public Internet 76, which is a global network, as indicated by the point in time T11, the unique number 101 displayed on the address display section 83 on the video phone terminal apparatus 71 on the one private network 72 and indicating the address of the terminal, which is registered with an SIP server or gatekeeper indicated by the reference numeral 102, on the public Internet 76, which is a global network, is notified to the other communication party through a telephone line, for example.

The unique number 103 displayed on the address display section 83 on the video phone terminal apparatus 77 on the other private network 78 and indicating the address of the terminal, which is registered with the SIP server or gatekeeper indicated by the reference numeral 102, on the public Internet 76, which is a global network, is further notified to the other communication party through a telephone line, for example.

Thus, by selecting and notifying the unique numbers 101 and 103 indicating the addresses of the terminals, which are registered with an SIP server or gatekeeper indicated by the reference numeral 102, to each other in accordance with the network that the other terminal to communicate belongs to, the unique numbers 101 and 103 indicating the addresses of the terminals, which are registered with an SIP server or gatekeeper indicated by the reference numeral 102, can be obtained by each other. Therefore, the communication with each other can be implemented by dialing the unique number 101 or 103 indicating the address of the terminal.

In order to communicate with the other terminal within the same private network 78, as indicated by the point in time T12, the IP address 79 of the terminal, which is displayed on the address display section 83 on the video phone terminal apparatus 77 on the other private network 78 is notified to the other communication party through a telephone line, for example. The IP address 93 of the terminal, which is displayed on the address display section 83 on the video phone terminal apparatus 92 on the other private network 78 is notified to the other communication party through a telephone line, for example.

Thus, by selecting and notifying the IP addresses 79 and 93, which are differently assigned every connection to the other private network 78, to the other communication party in accordance with the network that the other terminal to communicate belongs to, the IP addresses 79 and 93 of the terminals can be notified to each other. Therefore, the communication with each other can be implemented by dialing the IP address 79 or 93 of the other terminal.

In this way, good communication with the other communication terminal belonging to different network can be achieved at the point in time T11 and the subsequent point in time T12 by selecting an address displayed in accordance with the network that the other communication terminal belongs to and notifying it to the other communication terminal.

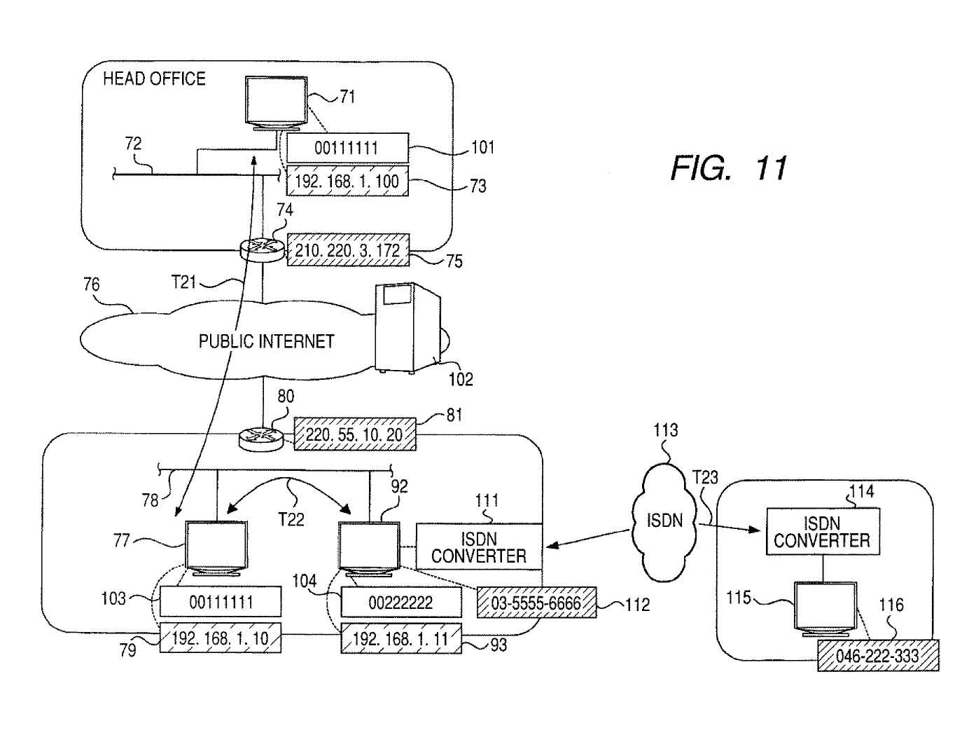

FIG. 11 is a diagram showing a usage of another video phone system. FIG. 11 shows an example in which an ISDN is employed in the case with the application of the server shown in FIG. 10.

In FIG. 11, in order to communicate with the other terminal over the public Internet 76, which is a global network, as indicated by the point in time T21, the unique number 101 displayed on the address display section 83 on the video phone terminal apparatus 71 on the one private network 72 and indicating the address of the terminal, which is registered with an SIP server or gatekeeper indicated by the reference numeral 102, on the public Internet 76, which is a global network, is notified to the other communication party through a telephone line, for example.

The unique number 103 displayed on the address display section 83 on the video phone terminal apparatus 77 on the other private network 78 and indicating the address of the terminal, which is registered with an SIP server or gatekeeper indicated by the reference numeral 102, on the public Internet 76, which is a global network, is further notified to the other communication party through a telephone line, for example.

Thus, by selecting and notifying the unique numbers 101 and 103 indicating the addresses of the terminals, which are registered with an SIP server or gatekeeper indicated by the reference numeral 102, to each other in accordance with the network that the other terminal to communicate belongs to, the unique numbers 101 and 103 indicating the addresses of the terminals, which are registered with an SIP server or gatekeeper indicated by the reference numeral 102, can be obtained by each other. Therefore, the communication with each other can be implemented by dialing the unique number 101 or 103, which is registered with an SIP server or gatekeeper indicated by the reference numeral 102, of the other party and indicating the address of the terminal.

In order to communicate with the other terminal within the same private network 78, as indicated by the point in time T22, the IP address 79 of the terminal, which is displayed on the address display section 83 on the video phone terminal apparatus 77 on the other private network 78 is notified to the other communication party through a telephone line, for example. The IP address 93 of the terminal, which is displayed on the address display section 83 on the video phone terminal apparatus 92 on the other private network 78 is notified to the other communication party through a telephone line, for example.

Thus, by selecting and notifying the IP addresses 79 and 93, which are differently assigned every connection to the other private network 78, to the other communication party in accordance with the network that the other terminal to communicate belongs to, the IP addresses 79 and 93 of the terminals can be notified to each other. Therefore, the communication with each other can be implemented by dialing the IP address 79 or 93 of the other terminal.

In order to use an ISDN 113, as indicated by the point in time T23, an ISDN number 112 of the terminal, which is displayed on the address display section 83 on the video phone terminal apparatus 92 on the other private network 78 is notified to the other communication party through a telephone line, for example. An ISDN number 116 of the terminal, which is displayed on the address display section 83 on a video phone terminal apparatus 115 on the line of the ISDN 113 is notified to the other communication party through a telephone line, for example.

Thus, by selecting and notifying the ISDN numbers 112 and 116 of the terminals, which are defined when the line of the ISDN 113 is laid, to each other in accordance with the network that the other terminal to communicate belongs to, the TSDN numbers 112 and 116 of the terminals can be notified to each other. Therefore, the communication with each other can be implemented by dialing the ISDN number 112 or 116 of the other terminal.

Here, the ISDN numbers 112 and 116 of the terminals are mutually converted to digital data by ISDN converters 111 and 114, with which the communication is performed by the ISDN 113 In this way, good communication with terminals belonging to different networks can be achieved at the point in time T21, the subsequent point in time T22 and the further subsequent point in time T23 by selecting an address displayed in accordance with the network that the other communication terminal belongs to and notifying it to the other communication terminal.

It is apparent that the invention is not limited to the embodiments above, and other constructions are possible without departing from the spirit and scope of the invention. For example, having described the examples of video phone terminal apparatus in the embodiments, the invention is applicable to cellular phone terminals, which can communicate images and voice.

What is claimed is:

1. A video phone terminal apparatus that communicates with another video phone terminal apparatus over a private network and a global network, the apparatus comprising:
a unique address defining section defining a unique address of a terminal of the apparatus;
an address-upon-connection obtaining section obtaining an address upon connection of the terminal to the private network; and
an address display section displaying an address unique to the terminal, which is defined by the unique address defining section, and the address upon connection of the terminal, which Is obtained by the address-upon-connection obtaining section.

2. The video phone terminal apparatus according to claim 1, wherein the address unique to the terminal, which is defined by the unique address defining section, includes a telephone line number of the terminal and the address of a server or gatekeeper, which is provided on the global network for converting the address of the terminal on the private network to a corresponding unique number.

3. The video phone terminal apparatus according to claim 2, further comprising:
a telephone line number storage section storing the telephone line number of the terminal;
a server address storage section storing the address of the server; and
a gatekeeper address storage section storing the address of the gatekeeper.

4. The video phone terminal apparatus according to claim 3, further comprising:
a server registering section registering the telephone line number stored in the telephone line number storage section, the server address stored in the server address storage section and the gatekeeper address stored in the gatekeeper address storage section with a storage section in the server or gatekeeper.

5. The video phone terminal apparatus according to claim 1, wherein the address upon connection of the terminal which is obtained by the address-upon-connection obtaining section, includes the address of the terminal on the private network and the address on the global network of a router, which is provided between the global network and the terminal.

6. The video phone terminal apparatus according to claim 5, further comprising:
a private network terminal address storage section storing the address of the terminal on the private network; and
a global network router address storage section storing the address on the global network of the router.

7. The video phone terminal apparatus according to claim 5, wherein the address-upon-connection obtaining section upon startup of the terminal obtains the address of the terminal on the private network from the server on the private network and obtains the address of the router from the router on the global network.

8. An address display method in a video phone terminal apparatus that communicates with another video phone terminal apparatus over a private network and a global network, the method comprising the steps of:
defining a unique address of a terminal of the apparatus;
obtaining an address upon connection of the terminal to the private network; and
displaying an address unique to the terminal, which is defined by the step of defining a unique address, and the address upon connection of the terminal, which is obtained by the step of obtaining the address upon connection.

9. The address display method according to claim 8, wherein the address unique to the terminal, which is defined by the step of defining a unique address, includes a telephone line number of the terminal and the address of a server or gatekeeper, which is provided on the global network for converting the address of the terminal on the private network to a corresponding unique number.

10. The address display method according to claim 9, further comprising the steps of:
storing the telephone line number of the terminal;
storing the address of the server; and
storing the address of the gatekeeper.

11. The address display method according to claim 9, further comprising the step of:
registering the telephone line number stored in the step of storing the telephone line number, the server address stored in the step of storing the server address and the gatekeeper address stored in the step of storing the gatekeeper address with a storage section in the server or gatekeeper.

12. The address display method according to claim 8, wherein the address upon connection of the terminal, which is obtained by the step of obtaining the address upon connection, includes the address of the terminal on the private network and the address on the global network of a router, which is provided between the global network and the terminal.

13. The address display method according to claim 12, further comprising the steps of:
storing the address of the terminal on the private network; and
storing the address on the global network of the router.

14. The address display method according to claim 12, wherein the step of obtaining the address upon connection upon startup of the terminal obtains the address of the terminal on the private network from the server on the private network and obtains the address of the router from the router on the global network.
